(19) United States
(12) Patent Application Publication
(10) Pub. No.: US 2023/0265607 A1
(43) Pub. Date: Aug. 24, 2023

(54) Treatment Liquid Composition, Set Of Ink Jet Ink Composition And Treatment Liquid Composition, And Treatment Method

(71) Applicant: SEIKO EPSON CORPORATION, Tokyo (JP)

(72) Inventor: Hideki OKADA, Shiojiri (JP)

(21) Appl. No.: 18/170,641

(22) Filed: Feb. 17, 2023

(30) Foreign Application Priority Data
Feb. 18, 2022 (JP) 2022-023583

(51) Int. Cl. D06P 1/52; D06P 1/642; D06P 5/20; C09D 11/322

(52) U.S. Cl. CPC D06P 1/5278; D06P 1/6424; D06P 5/2077; C09D 11/322; D10B 2401/14

(57) ABSTRACT

A treatment liquid composition contains a water-resistant agent selected from a polyamide epihalohydrin polymer and dimethylpyrazole-blocked isocyanate, and a polyamine compound.

The present application is based on, and claims priority from JP Application Serial Number 2022-023583, filed Feb. 18, 2022, the disclosure of which is hereby incorporated by reference herein in its entirety.

### BACKGROUND

### 1. Technical Field

The present disclosure relates to a treatment liquid composition, a set of an ink jet ink composition and a treatment liquid composition, and a treatment method.

### 2. Related Art

An ink jet recording method is a recording method including ejecting droplets of an ink jet ink composition (also referred to as an “ink” hereinafter) from fine nozzles and adhering the droplets to a recording medium. When an image is formed by ejecting an ink to a recording medium by an ink jet recording method, there has been known a technique of pre-treating the recording medium with a treatment liquid composition containing an aggregating agent in order to improve color development and the like of a recorded mater.

For example, JP-A-2021-020394 describes a treatment liquid composition containing a water-soluble cationic polymer, which is produced by reacting a monomer containing amine and epihalohydrin, a nonionic resin, an organic solvent, and water.

However, it is difficult to achieve both excellent color development and excellent wet friction fastness with little discoloration even during wet friction. It is also difficult to cause a fabric containing a treatment liquid composition adhered thereto to have excellent light resistance with little yellowing.

### SUMMARY

According to an aspect of the present disclosure, a treatment liquid composition includes a water-resistant agent selected from a polyamide epihalohydrin polymer and dimethylpyrazole-blocked isocyanate, and a polyamine compound.

According to an aspect of the present disclosure, a set of an ink jet ink composition and a treatment liquid composition is a set of an ink jet ink composition and the treatment liquid composition described above. The ink jet ink composition is an aqueous pigment ink jet ink containing pigment particles and resin particles, and the ink composition has a pH of over 8 and contains the particle components having a volume-average particle diameter of 20 nm or more and 500 nm or less.

According to an aspect of the present disclosure, a treatment method includes adhering the treatment liquid composition described above to a fabric, and heating the fabric to which the treatment liquid composition has been adhered. In the heating, the surface temperature of the fabric is 100° C. or more.

### DESCRIPTION OF EXEMPLARY EMBODIMENTS

An embodiment of the present disclosure is described below. The embodiment described below describes an example of the present disclosure. The present disclosure is not limited to the embodiment and includes various modifications carried out within a range where the gist of the present disclosure is not changed. In addition, configurations described below are not necessarily all essential configurations of the present disclosure.

### 1. Treatment Liquid Composition

A treatment liquid composition according to an embodiment of the present disclosure contains a water-resistant agent selected from a polyamide epihalohydrin polymer and dimethylpyrazole-blocked isocyanate, and a polyamine compound.

### 1. 1. Water-Resistant Agent

The treatment liquid composition may contain, as a water-resistant agent, one or both of a polyamide epihalohydrin polymer and dimethylpyrazole-blocked isocyanate. Also, the treatment liquid composition may contain, as a water-resistant agent, two or more polyamide epihalohydrin polymers or dimethylpyrazole-blocked isocyanates.

### 1. 1. 1. Polyamide Epihalohydrin Polymer

The polyamide epihalohydrin polymer is a polymer produced by polymerizing a monomer containing amine and epihalohydrin. Examples of the polyamide epihalohydrin polymer include a polyamine-epihalohydrin copolymer, a polyamide-epihalohydrin copolymer, a polyamide-polyamine-epihalohydrin copolymer, an amine-epihalohydrin copolymer, and the like. These polymers can be produced by a known method such as a method of polymerizing a monomer containing amine and epihalohydrin, a method of graft-polymerizing polyamide, produced by polymerizing a monomer containing amine and carboxylic acid, with a monomer containing epihalohydrin, or the like.

The epihalohydrin contains a halogen atom in the structure thereof. Examples of the halogen atom include F, Cl. Br, I, and the like. Among these halogen atoms, Cl is preferred, and thus the epihalohydrin is preferably epichlorohydrin. Therefore, the polyamide epihalohydrin polymer is preferably a polyamide epichlorohydrin polymer. Specifically, preferred are a polyamine-epichlorohydrin copolymer, a polyamide-epichlorohydrin copolymer, a polyamidepolyamine-epichlorohydrin copolymer, and an amine-epichlorohydrin copolymer. Among these, the polyamide-epichlorohydrin copolymer is more preferred.

Examples of commercial products of the polyamide epihalohydrin polymer include WS-4020, 4030, 4027, and TS-4070 (manufactured by Seiko PMC Corporation, polyamide-epichlorohydrin polymer), WS-4011 (manufactured by Seiko PMC Corporation, polyamine-epichlorohydrin polymer), AF-100, 251S, 255, 255LOX, and 2500 (manufactured by Arakawa Chemical Industries, Ltd., polyamide polyamine-epichlorohydrin polymer), Catiomaster PE-30 (manufactured by Yokkaichi Chemical Co., Ltd., dimethylamine-ethylenediamine-epichlorohydrin condensate), EPA-SK01 (manufactured by Yokkaichi Chemical Co., Ltd., polyamide polyamine-epichlorohydrin condensate), and the like.

The polyamide epihalohydrin polymers may be used alone or in combination of two or more.

The weight-average molecular weight of the polyamide epihalohydrin polymer is preferably 10,000 or more and 5,000,000 or less, more preferably 100,000 or more and 5,000,000 or less, still more preferably 500,000 or more and 5,000,000 or less, and particularly preferably 1,000,000 or more and 5,000,000 or less. When the weight-average molecular weight of the polyamide epihalohydrin polymer is within the range described above, the wet friction fastness of an image formed by using together with an ink jet ink composition is improved.

The content of the polyamide epihalohydrin polymer relative to the total mass of the treatment liquid composition is preferably 0.10% by mass or more, more preferably 0.30% by mass or more, still more preferably 0.50% by mass or more, and particularly preferably 0.70% by mass or more. The content of the polyamide epihalohydrin polymer relative to the total mass of the treatment liquid composition is preferably 5.0% by mass or less, more preferably 3.0% by mass or less, still more preferably 1.5% by mass or less, and particularly preferably 1.2% by mass or less. The polyamide epihalohydrin polymer at a content within the range described above enables to form a recorded matter having better valance between the color development, friction fastness such as dry friction fastness and wet friction fastness, texture, and light resistance.

### 1. 1. 2. Dimethylpyrazole-Blocked Isocyanate

Dimethylpyrazole-blocked isocyanate is a compound produced by blocking an isocyanate group of an isocyanate compound with a dimethylpyrazole group. That is, the isocyanate group of the compound is stabilized by masking with dimethylpyrazole (preferably 3,5-dimethylpyrazole) serving as a blocking agent. This makes handling safe and can cause high reactivity by reproduction of the isocyanate group due to dissociation of the blocking agent by treatment of heating or the like. The use of dimethylpyrazole-blocked isocyanate can suppress yellowing of a fabric and can more improve light resistance.

The isocyanate compound is not particularly limited as long as it has at least two or more isocyanate groups in its molecule, and a known polyisocyanate compound can be used. Examples thereof include diisocyanate compounds such as alkylene (preferably having 1 or more and 12 or less carbon atoms) diisocyanate, aryl diisocyanate, and cycloalkyl diisocyanate, and modified polyisocyanate compounds such as dimer, trimer, and the like of these diisocyanate compounds.

A modified polyisocyanate compound derived from a diisocyanate compound is not particularly limited as long as it has two or more isocyanate groups, and examples thereof include polyisocyanate having a biuret structure, an isocyanurate structure, a urethane structure, a uretdione structure, an allophanate structure, a trimer structure, or the like, aliphatic isocyanate adducts of trimethylolpropane, and the like. Also, polymeric MDI (MDI=diphenylmethane diisocyanate) can be used as the polyisocyanate compound.

A commercial product can be used as the dimethylpyrazole-blocked isocyanate. Examples of a commercial dimethylpyrazole-blocked isocyanate include “NK Assist” series manufactured by Nicca Chemical Co., Ltd., such as NK Assist FU, NK Assist IS-100, NK Assist IS-80, NK Assist V, NK Assist NY, NK Assist NY-27, NK Assist NY-30, and NK Assist NY-50, Fixer series manufactured by Murayama Chemical Laboratory Co., Ltd., and the like.

The isocyanate group produced from the dimethylpyrazole-blocked isocyanate can react with a material having a hydroxyl group, such as cellulose or the like. Also, the isocyanate group can react with a group other than a hydroxyl group, and these reactions can be controlled by the temperature and concentration.

When the fabric to which the treatment liquid composition is adhered contains cellulose, the isocyanate group produced from the dimethylpyrazole-blocked isocyanate reacts with a hydroxyl group of cellulose to produce a urethane bond, by which both groups can be chemically bonded to each other. Also, the degree of reaction with cellulose or the like can be controlled by adjusting the degree of heating and concentration. For example, after adhered to the fabric, blocked isocyanate groups can also be partially or entirely allowed to remain unreacted on the fabric.

The urethane bond is produced by reaction of an isocyanate group with a hydroxyl group. However, an object reacting with an isocyanate group is not limited to a hydroxyl group, and a reaction partner may be changed according to various chemical structures contained in objects. For example, an isocyanate group reacts with an amino group to produce a urea bond, plural isocyanate bonds react with water to produce a urea bond, a urea bond reacts with an isocyanate group to produce a biuret bond, and a urethan bond reacts with an isocyanate group to produce an allophanate bond. These bonds can be positively produced or not produced by adjusting the reaction temperature or the like, and thus a bond can be produced according to the chemical structure present in an object to which the treatment liquid composition is adhered.

The content of the dimethylpyrazole-blocked isocyanate relative to the total amount of the treatment liquid composition is 0.1% by mass or more and 15.0% by mass or less, preferably 0.2% by mass or more and 10.0% by mass or less, more preferably 0.2% by mass or more and 5.0% by mass or less, and still more preferably 0.5% by mass or more and 2.0% by mass or less. When the content of the dimethylpyrazole-blocked isocyanate is within the range described above, a suitable amount of isocyanate group can be easily bonded and/or arranged in a fabric to which an isocyanate group is adhered. For example, when an ink jet ink composition is adhered to the fabric and heated, a component of the ink jet ink composition can be reacted with an isocyanate group. This can prevent a coloring material contained in the ink jet ink composition from falling off from the fabric, and thus wet friction fastness of an image can be sufficiently achieved.

### 1. 2. Polyamine Compound

The treatment liquid composition contains the polyamine compound. The polyamine compound has the properties of a cationic polymer. Any polyamine compound can be used as long as it has an amino group in its structure, and a known amine compound can be properly selected and used. Examples thereof include a polyamine resin, a polyamide resin, a polyallylamine resin, and the like. The polyamine resin is a resin having an amino group in the main skeleton of the resin. The polyamide resin is a resin having an amide group in the main skeleton of the resin. The polyallylamine resin is a resin having a structure derived from an allyl group in the main skeleton of the resin.

Examples of a commercial product of the polyamine compound include Unisence KHE103L (an aqueous solution of hexamethylenediamine/epichlorohydrin resin, pH of 1% aqueous solution: about 5.0, viscosity: 20 to 50 (mPa·s), solid content concentration: 50% by mass), and Unisence KHE104L (an aqueous solution of dimethylamine/epichlorohydrin resin, pH of 1% aqueous solution: about 7.0, viscosity: 1 to 10 (mPa·s), solid content concentration: 20% by mass), which are manufactured by Senka Corporation, and the like. Examples of a commercial product of a cationic polyamine-based resin include FL-14 (manufactured by SNF, Inc.), Arafix 100, 251S, 255, and 255LOX (manufactured by Arakawa Chemical Industries, Ltd.), DK-6810, 6853, and 6885; WS-4010, 4011, 4020, 4024, 4027, and 4030 (manufactured by Seiko PMC Corporation), Papiogen P-105 (manufactured by Senka Corporation), Sumirez Resin 650(30), 675A, 6615, and SLX-1 (manufactured by Taoka Chemical Co., Ltd.), Catiomaster (registered trade name) PD-1, 7, 30, A, PDT-2, PE-10, PE-30, DT-EH, EPA-SK01, and TMHMDA-E (manufactured by Yokkaichi Chemical Co., Ltd.), and Jetfix 36N, 38A, N700, and 5052 (manufactured by Satoda Chemical Industrial Co., Ltd.).

Examples of the polyallylamine resin include polyallylamine hydrochloride, polyallylamine amide sulfate, allylamine hydrochloride-diallylamine hydrochloride copolymer, allylamine acetate-diallylamine acetate copolymer, allylamine acetate-diallylamine acetate copolymer, allylamine hydrochloride-dimethylallylamine hydrochloride copolymer, allylamine-dimethylallylamine copolymer, polydiallylamine hydrochloride, polymethyldiallylamine hydrochloride, polymethyldiallylamine amide sulfate, polymethyldiallylamine acetate, polydiallyldimethyl ammonium chloride, diallylamine acetate-sulfur dioxide copolymer, diallylmethylethyl ammonium ethyl sulfate-sulfur dioxide copolymer, methyldiallylamine hydrochloride-sulfur dioxide copolymer, diallyldimethyl ammonium chloride-sulfur dioxide copolymer, diallyldimethyl ammonium chloride-acrylamide copolymer, and the like.

The polyamine compound has the function of aggregating the component of the ink jet ink composition. The aggregation can, for example, enhance the color development of a pigment and/or enhance the fixability of resin particles.

The content of the polyamine compound relative to the total amount of the treatment liquid composition is 0.1% by mass or more 15.0% by mass or less, preferably 0.2% by mass or more and 10.0% by mass or less, more preferably 0.2% by mass or more and 5.0% by mass or less, and still more preferably 0.5% by mass or more and 2.0% by mass or less. When the content of the polyamine compound is within the range described above, the dispersed component in the ink jet ink composition can be aggregated satisfactorily. Thus, for example, the color development of a coloring material contained in the ink jet ink composition can be sufficiently obtained.

### 1. 3. Other Components

### 1. 3. 1. Solvent

### Water

The treatment liquid composition according to the present embodiment preferably contains water as a solvent. The water may be a main solvent in the treatment liquid composition and is a component evaporated and scattered by drying. Examples of the water include water from which ionic impurities are removed as much as possible, such as pure water such as ion exchange water, ultrafiltered water, reverse osmosis water, distilled water, and the like, and ultrapure water. In addition, the use of water sterilized by ultraviolet irradiation, addition of hydrogen peroxide, or the like can prevent the occurrence of mold and bacteria when the treatment liquid composition is stored for a long period of time.

The content of water is not particularly limited, but the content relative to the total mass of the treatment liquid composition may be, for example, 50% by mass or more, 60% by mass or more, or 70% by mass or more. The upper limit of the content of water contained in the treatment liquid composition may be 99% by mass or less, 98% by mass or less, or 97% by mass or less.

### Water-Soluble Organic Solvent

The treatment liquid composition according to the present embodiment may contain a water-soluble organic solvent as a solvent.

Examples of the water-soluble organic solvent include a polyol compound, a glycol ether, a betaine compound, and the like.

The polyol compound is, for example, a polyol compound (preferably a diol compound) having 2 or more and 6 or less carbon atoms in its molecule and having one ether bond in its molecule, or the like. Specific examples thereof include 1,2-pentanediol, methyl triglycol (triethylene glycol monomethyl ether), butyl triglycol (triethylene glycol monobutyl ether), trimethylolpropane, butyl diglycol (diethylene glycol monobutyl ether), dipropylene glycol monopropyl ether, glycerin, 1,2-hexanediol, 1,2-heptanediol, 1,3-propanediol, 1,2-butanediol, 1,3-butanediol, 1,4-butanediol, 2,3-butanediol, 2-methyl-3-pheoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,3-propanediol, 1,2-pentanediol, 1,5-pentanediol, 1,6-hexanediol, 2-methyl-2,4-pentanediol, 3-methyl-1,5-pentanediol, and the like.

For example, the glycol ether is preferably glycol monoalkyl ether selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. More preferred are triethylene glycol monomethyl ether, triethylene glycol monobutyl ether, dipropylene glycol monopropyl ether, and the like.

The betaine compound is a compound (intramolecular salt) having positive charge and negative charge at positions not adjacent to each other in the same molecule, but not having a dissociable hydrogen atom bonded to an atom having positive charge, and thus not having charge as a whole in the molecule. The betaine compound is preferably a N-alkyl substituted amino acid and more preferably a N-trialkyl substituted amino acid. Examples of the betaine compound include trimethyl glycine (also referred to as “glycine betaine”), γ-butyrobetaine, formalin, trigonelline, carnitine, homoserine betaine, valine betaine, lysine betaine, ornithine betaine, alanine betaine, stachydrine, glutamic acid betaine, and the like, and preferred examples include trimethyl glycine and the like.

In addition, a pyrrolidone derivative may be used as the water-soluble organic solvent. Examples of the pyrrolidone derivative include N-methyl-2-pyrrolidone, N-ethyl-2-pyrrolidone, N-vinyl-2-pyrrolidone, 2-pyrrolidone, N-butyl-2-pyrrolidone, 5-methyl-2-pyrrolidone, and the like.

The water-soluble organic solvents may be used as a mixture of plural types. When the water-soluble organic solvent is contained, the content relative to the total mass of the treatment liquid composition is, for example, preferably 10% by mass or less, more preferably 5% by mass or less, and still more preferably 3% by mass or less.

### 1. 3. 2. Surfactant

The treatment liquid composition according to the present embodiment may contain a surfactant. The surfactant has the function of decreasing the surface tension of the treatment liquid composition to improve wettability to a recording medium.

For example, an acetylene glycol-based surfactant, a silicone-based surfactant, and a fluorine-based surfactant are preferably used as the surfactant. Among these, the acetylene glycol-based surfactant is more preferably contained.

Examples of the acetylene glycol-based surfactant include, but are not particularly limited to, Surfynol 104 (HLB value=4), 104E, 104H, 104A, 104BC, 104DPM, 104PA, 104PG-50, 104S, 420, 440, 465, 485 (HLB value=17), SE, SE-F, 504, 61, DF37, CT111, CT121, CT131, CT136, TG, GA, and DF110D (above all trade names, manufactured by Air Products and Chemicals, Inc.), Olfine B, Y, P, A, STG, SPC, E1004, E1010 (HLB value=14), PD-001, PD-002W, PD-003, PD-004, EXP. 4001, EXP. 4036, EXP. 4051, AF-103, AF-104, AK-02, SK-14, and AE-3 (all above trade names, manufactured by Nissin Chemical Industry Co., Ltd.), Acetynol E00, E00P, E40, and, E100 (all above trade names, manufactured by Kawaken Fine Chemicals Co., Ltd.), and the like.

The silicone-based surfactant is not particularly limited but is, for example, preferably a polysiloxane-based compound. The polysiloxane-based compound is not particularly limited but is, for example, polyether-modified organosiloxane. Examples of a commercial product of the polyether-modified organosiloxane include BYK-306, BYK-307, BYK-333, BYK-341, BYK-345, BYK-346, and BYK-348 (above trade names, manufactured by BYK Chemie Japan K. K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (above trade names, manufactured by Shin-Etsu Chemical Co., Ltd.), and the like.

A fluorine-modified polymer is preferably used as the fluorine-based surfactant, and examples thereof include BYK-340 (manufactured by BYK Chemie Japan K. K.).

The surfactants may be used alone or in combination of two or more.

The lower limit value of the content of the surfactant relative to the total mass (100% by mass) of the treatment liquid composition is preferably 0.1% by mass or more, more preferably 0.3% by mass or more, and still more preferably 0.5% by mass or more. The upper limit value of the content of the surfactant relative to the total mass (100% by mass) of the treatment liquid composition is preferably 10% by mass or less, more preferably 7% by mass or less, still more preferably 5% by mass or less, particularly preferably 2% by mass or less, and further preferably 1% by mass or less.

In selecting the surfactant, the HLB value is preferably taken into consideration. The lower limit of the HLB value of the surfactant is preferably 6 or more, more preferably 8 or more, and still more preferably 10 or more, and the upper limit of the HLB value is preferably 18 or less, more preferably 16 or less, and still more preferably 14 or less. With the HLB value within the range described above, color development may be more improved.

In the present specification, the HLB value is a value calculated by formula (1) below using the ratio (also simply referred to as the “I/O value” hereinafter) of nonpolarity value (I) to polarity value (O) in the organic concept map.

HLB value=(nonpolarity value(I)/polarity value(O))×10 (1)

Specifically, the I/O value can be calculated based on the documents “Systematic Organic Qualitative Analysis (mixture part)” written by Minoru Fujita, Kazama Shobo Co., Ltd., 1974; “Theoretical Chemistry of Dyeing” written by Nobuhiko Kuroki, Maki Shoten, 1966; and “Organic Compound Separation Method” written by Hiroo Inoue, Shouka-bo, 1990.

### 1. 3. 3. Water-Insoluble Component

The treatment liquid composition according to the present embodiment may contain a water-insoluble component. The water-insoluble component represents a component which is not dissolved or substantially not dissolved in water, and examples thereof include a water-insoluble coloring material, a water-insoluble resin, wax, a water-insoluble organic solvent, and the like.

### Water-Insoluble Coloring Material

Examples of the water-insoluble coloring material include an oil-soluble dye, pigment particles, and the like. Usable examples of the oil-soluble dye include, but are not particularly limited to, a disperse dye, a vat dye, an organic solvent-soluble dye, and the like. The same as the pigment particles contained in an ink jet ink composition described later can be used as the pigment particles.

### Water-Insoluble Resin

Examples of the water-insoluble resin include resins, such as a urethane-based resin, an acrylic resin, a styrene-acrylic resin, a fluorene-based resin, a polyolefin-based resin, a rosin-modified resin, a terpene-based resin, a polyester-based resin, a polyamide-based resin, an epoxy-based resin, a vinyl chloride-based resin, a vinyl chloride-vinyl acetate copolymer, an ethylene-vinyl acetate-based resin, and the like. The water-insoluble resin is preferably used in the form of resin particles, such as a resin emulsion, a powder, or the like, and is more preferably a resin emulsion of resin particles. The water-insoluble resins may be used alone or in combination of two or more.

The urethane-based resin is a general term of resins having a urethane bond. A urethane-based resin having a bond other than a urethane bond may be used as the urethane-based resin, and examples thereof include a polyether-type urethane resin having an ether bond in its main chain, a polyester-type urethane resin having an ester bond in its main chain, a polycarbonate-type urethane resin having a carbonate bond in its main chain, and the like.

The acrylic resin is a general term of polymers produced by polymerizing at least an acrylic monomer such as (meth)acrylic acid, (meth)acrylate ester or the like as one component, and examples thereof include a resin produced from an acrylic monomer, a copolymer of an acrylic monomer and another monomer, and the like. For example, an acrylic-vinyl-based resin, which a copolymer of an acrylic monomer and a vinyl-based monomer, or the like can be used. Further, for example, a copolymer with a vinyl-based monomer, such as styrene, can be used.

Also, acrylamide, acrylonitrile, and the like can be used as the acrylic monomer. A commercial product may be used as the acrylic resin. In the present specification, the acrylic resin may be a styrene-acrylic resin described later. In the present specification, the description “(meth)acryl” represents at least one of “acryl” and “methacryl”.

The styrene-acrylic resin is a copolymer produced from a styrene monomer and an acrylic monomer, and examples thereof include a styrene-acrylic acid copolymer, a styrene-methacrylic acid copolymer, a styrene-methacrylic acid-acrylate ester copolymer, a styrene-α-methylstyrene-acrylic acid copolymer, a styrene-α-methylstyrene-acrylic acid-acrylate ester copolymer, and the like. A commercial product may be used as the styrene-acrylic resin.

The polyolefin-based resin has a structural skeleton having an olefin such as ethylene, propylene, butylene, or the like, and a known resin can be properly selected and used. A commercial product may be used as the olefin resin.

Examples of a commercial product of a resin particle emulsion which can be used in the present embodiment are described below.

Examples of a urethane-based resin emulsion include Superflex 870, 800, 150, 420, 460, 470, 610, 620, 700, 460s, 840, and E-4000 (trade names manufactured by DKS Co., Ltd.), Permarin UA-150 (trade name manufactured by Sanyo Chemical Industries Co., Ltd.), Suncure 2710 (trade name manufactured by Lubrizol Corporation), NeoRez R-9660, R-9637, and R-940 (trade manes manufactured by Kusumoto Chemicals, Ltd.), Adeka Bontiter HUX-380 and 290K (trade names manufactured by ADEKA Corporation), Resamine D-1060, D-2020, D-4080, D-4200, D-6300, and D-6455 (trade names manufactured by Dainichiseika Color & Chemicals Mfg. Co., Ltd.), and Takelac W-6020, W-635, W-6061, W-605, W-635, W-6021, and W-512-A-6 (trade names manufactured by Mitsui Chemicals Polyurethane Co., Ltd.).

Examples of an acrylic resin emulsion include Boncoat 4001 (trade name manufactured by DIC Corporation), Polysol AM-710, AM-920, AM-2300, AP-4735, AT-860, and PSASE-4210E (trade names manufactured by Showa Denko K. K.), Saivinol SK-200 (trade name manufactured by Saiden Chemical Industry Co., Ltd.), AE-120A (trade name manufactured by JSR Corporation), Vinyblan 2682 (trade name manufactured by Nissin Chemical Industry Co., Ltd.), Movinyl 952B and 718A (trade names manufactured by Nihon Gosei Kako Co., Ltd.), K-854 (trade name manufactured by Chuo Rika Kogyo Co., Ltd.), and Nipol LX852 and LX874 (trade names manufactured by Zeon Corporation).

Examples of a styrene acrylic resin emulsion include Microgel E-1002 and E-5002 (trade names manufactured by Nippon Paint Co., Ltd.), Boncoat 5454 (trade name manufactured by DIC Corporation), Polysol AP-7020 and SAE1014 (trade names manufactured by Showa Denko K. K.), Vinyblan 2586 (trade name manufactured by Nissin Chemical Industry Co., Ltd.), Arobase CB-1200 and CD-1200 (trade names manufactured by Unitika Ltd.), Movinyl 966A, 7320, and 975N (trade names manufactured by Nihon Gosei Kako Co., Ltd.), and Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names manufactured by BASF Corporation).

Examples of other resin emulsions include Elitel KA-5071S, KT-8803, KT-9204, KT-8701, KT-8904, and KT-0507 (trade names manufactured by Unitika Ltd., polyester resin emulsion), Hitech SN-2002 (trade name manufactured by Toho Chemical Industry Co., Ltd, polyester resin emulsion), Polysol SH-502 (trade name manufactured by Showa Denko K. K., vinyl acetate resin emulsion), Polysol AD-13, AD-2, AD-10, AD-96, AD-17, and AD-70 (trade names manufactured by Showa Denko K. K. ethylene-vinyl acetate resin emulsion), Polysol PSASE-6010 (trade name manufactured by Showa Denko K. K. ethylene-vinyl acetate resin emulsion), AE373D (trade name manufactured by E-Tech Co., Ltd., carboxyl-modified styrene-acrylic resin emulsion), Seikadyne 1900W (trade name manufactured by Dainichiseika Color & Chemicals Mfg. Co., Ltd., ethylene-vinyl acetate resin emulsion), Vinylblan 2886 (trade name manufactured by Nissin Chemical Industry Co., Ltd., vinyl acetate-acrylic resin emulsion), Vinylblan 5202 (trade name manufactured by Nissin Chemical Industry Co., Ltd., acetic acid-acrylic resin emulsion), NK Binder R-5HN (trade name manufactured by Shin-Nakamura Chemical Co., Ltd.), and Hydran WLS-210 (trade name manufactured by DIC Corporation, noncrosslinkable polyurethane emulsion).

### Wax

Examples of the wax include, but are not particularly not limited to, hydrocarbon wax, and ester wax which is a condensate of fatty acid and monohydric alcohol or polyhydric alcohol. Examples of hydrocarbon wax include, but are not particularly limited to, paraffin wax, and polyolefin wax such as polyethylene wax and polypropylene wax, and the like. These waxes may be used alone or in combination of two or more.

Examples of a commercial product of paraffin wax include AQUACER 497 and AQUACER 539 (above trade names manufactured by BYK Co., Ltd.).

Examples of a commercial product of polyolefin wax include Chemipearl 5120, 5650, and S75N (trade names, manufactured by Mitsui Chemicals Inc.) and AQUACER 501, AQUACER 506, AQUACER 513, AQUACER 515, AQUACER 526, AQUACER 593, and AQUACER 582 (trade names, manufactured by BYK Co., Ltd.).

The water-insoluble components may be used alone or in combination of two or more.

The treatment liquid composition according to the present embodiment preferably does not contain over 1.0% by mass, more preferably does not contain over 0.70% by mass, still more preferably does not contain over 0.50% by mass, particularly preferably does not contain over 0.30% by mass, and further particularly preferably does not contain over 0.10% by mass, of the water-insoluble component relative to the total mass of the treatment liquid composition, and the water-insoluble component may not be contained. When the water-insoluble component is contained, there is a tendency that the friction fastness and the like can be improved, but coating stability may be degraded. However, the treatment liquid composition according to the present embodiment has a tendency that the friction fastness and coating stability can be improved even when the content of the water-insoluble component is within the range described above. The water-insoluble component preferably includes resin particles from the viewpoint that the effect exhibited by the present disclosure can be more acquired.

### 1. 4. Other Component

If required, the treatment liquid composition according to the present embodiment may contain a pH adjuster, a preservative/anti-mold agent, an anti-rust agent, a chelating agent, a viscosity modifier, a solubilizer, an antioxidant, etc.

### pH Adjuster

Examples of the pH adjuster include amines and modified products thereof, such as diethanolamine, triethanolamine, propanolamine, morpholine, and the like; organic acids such as acetic acid, citric acid, phthalic acid, oxalic acid, succinic acid, adipic acid, amino acids, and the like; inorganic salts such as sodium hydroxide, potassium hydroxide, and the like; ammonium hydroxide; quaternary ammonium hydroxide (tetramethyl ammonium); and the like.

### Preservative/Anti-Mold Agent

Examples of the preservative/anti-mold agent include sodium benzoate, pentachlorophenol sodium, 2-pyridinethiol-1-oxide sodium, sodium sorbate, sodium dehydroacetate, 1,2-dibenzinethiazolin-3-one (ICI Co., Ltd., Proxel CRL, Proxel BND, Proxel GXL, Proxel XL-2, and Proxel TN), and the like.

### Chelating Agent

The chelating agent has the property of capturing an ion. Examples of the chelating agent include ethylenediamine tetraacetate salt (EDTA), ethylenediamine nitrilotriacetate salt, hexametaphosphate salt, pyrophosphate salt, metaphosphate salt, and the like.

### 1. 5. Production Method

The treatment liquid composition according to the present embodiment can be produced by mixing the components described above in any desired order and, if required, removing impurities by filtration or the like. A method preferably used as a method for mixing the components includes sequentially adding the materials in a vessel provided with a stirrer, such as a mechanical stirrer, a magnetic stirrer, or the like, and mixing and stirring the materials. If required, a filtration method can be performed by centrifugal filtration, filter filtration, or the like.

### 1. 6. Physical Properties of Treatment Liquid Composition

The physical properties, such as pH, surface tension, viscosity, etc., of the treatment liquid composition according to the present embodiment may be adjusted within the respective desired ranges.

The treatment liquid composition according to the present embodiment preferably has a pH of less than 7, more preferably a pH of less than 6, still more preferably a pH of less than 5, and particularly preferably a pH of less than 4. When an ink jet ink composition described later which can be used together with the treatment liquid composition according to the present embodiment has a pH exceeding 8, dispersion is often stabilized. With the treatment liquid composition having a pH within the range described above, the dispersion of the ink is easily destabilized when mixed with the ink jet ink composition, and aggregation may be accelerated to improve reactivity with the ink, thereby more improving color development.

The treatment liquid composition according to the present embodiment preferably has a surface tension at 25° C. of 10 mN/m or more and 40 mN/m or less, and more preferably 25 mN/m or more and 40 mN/m or less. The surface tension can be measured by, for example, determining the surface tension when a platinum plate is wet with the treatment liquid composition in an environment of 25° C. using automatic surface tensiometer CBVP-Z (trade name, manufactured by Kyowa Interface Science Co., Ltd.).

The treatment liquid composition according to the present embodiment preferably has a viscosity at 20° C. of 2 mPa·s or more and 15 mPa·s or less, more preferably 2 mPa·s or more and 5 mPa·s or less, and still more preferably 2 mPa·s or more and 3.6 mPa·s or less. The viscosity can be measured by, for example, measuring viscosity in an environment of 40° C. or 20° C. using viscoelasticity tester MCR-300 (trade name, manufactured by Pysica Corporation).

### 1. 7. Application

The treatment liquid composition according to the present embodiment is preferably used for an aqueous pigment ink jet ink. In addition, an ink jet ink composition described later can be preferably applied to the aqueous pigment ink jet ink.

The treatment liquid composition according to the present embodiment is preferably used by coating a fabric. When an image is formed on a fabric using an ink, high quality is required in terms of color development, wet friction fastness, texture, etc. The treatment liquid composition according to the present embodiment has a tendency that both excellent color development and excellent wet friction fastness, which are required for forming an image on a fabric, can be achieved, and texture can be improved.

Examples of a material constituting a fabric include natural fibers of cotton, hemp, wool, silk, and the like; synthetic fibers of polypropylene, polyester, acetate, triacetate, polyamide, polyurethane, and the like; biodegradable fibers of polylactic acid and the like; and the like. A mixture of these fibers may be used.

The polyamide epihalohydrin polymer contained in the treatment liquid composition according to the present embodiment has a function of improving water resistance that swelling of fibers due to containing of water can be decreased by bonding of an amide moiety or the like in the structure to a hydroxyl group in the fabric fibers, and also has a function of improving structural strength by crosslinking of an epihalohydrin moiety. Al least one of the functions acts regardless of the material constituting the fabric. Therefore, even when the material constituting the fabric is any one of natural fibers of cotton and the like and synthetic fibers of polyester and the like, the treatment liquid composition according to the present embodiment exhibits the effect of improving the excellent wet friction fastness.

Also, the dimethylpyrazole-blocked isocyanate contained in the treatment liquid composition according to the embodiment easily bonds to a hydroxyl group, and thus the material constituting a fabric more preferably contains fibers containing cellulose, such as cotton or the like. This causes the resultant image to exhibit excellent wet friction fastness.

The whiteness of the fabric is preferably 70 or more, more preferably 80 or more, and still more preferably 90 or more. The whiteness represents a L* value in the CIE/L*a*b* color system. The whiteness can be measured by using a colorimeter “Gretag Macbeth Spectrolino” (trade name manufactured by X-Rite Inc.). The fabric having a whiteness within the range described above is a relatively white fabric and thus has a problem that yellowing is particularly noticeable. However, the treatment liquid composition according to the present embodiment causes little yellowing and thus can be used without causing the problem of yellowing even in such a fabric.

### 1. 8. Operation and Effect, Etc.

The treatment liquid composition according to the embodiment can impart water resistance to the fibers of a recording medium by the water-resistant agent, and thus the treatment liquid composition makes it easy to suppress the swelling of fibers and enables the ink jet ink composition to be hardly separated from the fibers. Also, the treatment liquid composition according to the embodiment contains the polyamine compound as an aggregating agent, and thus the treatment liquid composition easily stays on the surfaces of the fibers of the recording medium and is slightly dissolved. Therefore, reaction with the ink jet ink composition can be more produced on the fiber surfaces. This easily improves color development due to maintenance of wet fastness. Further, the treatment liquid composition according to the embodiment can enhance the light resistance of an image formed by the ink jet ink composition.

### 2. Set of Ink Jet Ink Composition and Treatment Liquid Composition

A set of an ink jet ink composition and a treatment liquid composition according to an embodiment of the present disclosure is a set of an ink jet ink composition and the treatment liquid composition described above. The ink jet ink composition is an aqueous pigment ink jet ink containing pigment particles and resin particles and has a pH of over 8 and contains the particle components having a volume-average particle diameter of 20 nm or more and 500 nm or less.

In the set of the ink jet ink composition and the treatment liquid composition, the ink jet ink composition and treatment liquid composition included in the set may be used as a set for recording. That is, the ink composition and the treatment liquid composition used as a set for recording are referred to as the “set of the ink jet ink composition and the treatment liquid composition”.

The ink jet ink composition included in the set of the ink jet ink composition and the treatment liquid composition according to the present embodiment (also referred to as the “ink treatment liquid set” hereinafter) causes dispersion stabilized at a pH of over 8. When the ink jet ink composition is mixed with the treatment liquid composition, dispersion of the ink is easily destabilized, and aggregation of the particle components is promoted. Therefore, there is a tendency that reactivity of the ink with the treatment liquid is improved, thereby causing particularly excellent color development. Thus, the ink treatment liquid set according to the present embodiment can achieve both particularly excellent color development and excellent wet friction fastness.

Each of the components of the treatment liquid composition included in the ink treatment liquid set according to the present embodiment is as described above, and thus description thereof is omitted. Each of the components contained in the ink jet ink composition included in the ink treatment liquid set according to the present embodiment is described below.

### 3. Ink Jet Ink Composition

The ink jet ink composition included in the ink treatment liquid set according to the present embodiment is an aqueous pigment ink jet ink containing the pigment particles and the resin particles.

### 3. 1. Pigment Particles

Examples of the pigment particles include particles of organic pigments such as cyan, magenta, yellow, black, and the like, and special color pigments such as a white pigment, a photoluminescent pigment, and the like.

Examples of the organic pigments include a quinacridone-based pigment, a quinacridone quinone-based pigment, a dioxane-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzimidazolone-based pigment, a thioindigo-based pigment, an isoindolinone-based pigment, an azomethine-based pigment, a dye chelate, a lake pigment, a nitro-based pigment, a nitroso-based pigment, aniline black, azo-based pigments such as an insoluble azo pigment, a condensed azo pigment, an azo lake, a chelate azo pigment, and the like, and the like.

Examples of the organic pigments include the following.

Examples of a pigment used for a cyan ink include C. I. Pigmen Blue 1, 2, 3, 15:3, 15:4, 16, 22, 60, and the like; and C. I. Vat Blue 4, 60, and the like, and one or a mixture of two or more selected from the group consisting of C. I. Pigment Blue 15:3, 15:4, and 60 is preferably used.

Examples of a pigment used for a magenta ink include C. I. Pigment Red 5, 7, 12, 48(Ca), 48(Mn), 57(Ca), 57:1, 112, 122, 123, 168, 184, and 202, and C. I. Pigment Violet 19, and the like. Preferred is one or a mixture of two or more selected from the group consisting of C. I. Pigment Red 122, 202, and 209 and C. I. Pigment Violet 19.

Examples of a pigment used for a yellow ink include C. I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferred is one or a mixture of two or more selected from the group consisting of C. I. Pigment Yellow 74, 109, 110, 128, and 138.

A pigment used for an orange ink is C. I. Pigment Orange 36 or 43 or a mixture thereof.

A pigment used for a green ink is C. I. Pigment Green 7 or 36 or a mixture thereof.

Examples of carbon black include furnace black, lamp black, acetylene black, channel black (C. I. Pigment Black 7), and the like, and examples of a commercial product include No. 2300, 900, MCF88, No. 20B, No. 33, No. 40, No. 45, No. 52, MA7, MA8, MA100, No2200B, and the like (trade names, manufactured by Mitsubishi Chemical Corporation), Color black FW1, FW2, FW2V, FW18, FW200, 5150, 5160, and S170, Printex 35, U, V, and 140U, Special Black 6, 5, 4A, 4, 250, and the like (trade names, manufactured by Degussa Corporation), Conductex SC, Raven 1255, 5750, 5250, 5000, 3500, 1255, 700, and the like (all trade names, manufactured by Columbia Carbon Co., Ltd.), and Regal 400R, 330R, and 660R, Mogul L, Monarch 700, 800, 880, 900, 1000, 1100, 1300, and 1400, Elftex 12, and the like (trade names, manufactured by Cabot Corporation). These carbon blacks may be used alone or as a mixture of two or more.

The photoluminescent pigment is not particularly limited as long as it can exhibit photoluminescence when adhered to a medium, and examples thereof include metal particles of one or an alloy (also referred to as a “metal pigment”) of two or more selected from the group consisting of aluminum, silver, gold, platinum, nickel, chromium, tin, zinc, indium, titanium, and copper, and a pearl pigment having pearl luster. Typical examples of the pearl pigment include pigments having pearl luster or interference luster, such as titanium dioxide-coated mica, fish scale flakes, bismuth oxychloride, and the like. In addition, the photoluminescent pigment may be surface-treated for suppressing reaction with water.

Examples of the white pigment include metal compounds such as metal oxides, barium sulfate, calcium carbonate, and the like. Examples of metal oxides include titanium dioxide, zinc oxide, silica, alumina, magnesium oxide, and the like. In addition, particles having a hollow structure may be used as the white pigment.

These types of the pigment particles may be used alone or in combination of two or more. The pigment particles are preferably organic pigment particles from the viewpoint of storage stability such as light resistance, whether resistance, gas resistance, etc.

The pigment particles can be preferably stably dispersed in the ink. For example, the pigment particles may be used as self-dispersible pigment particles prepared by, oxidizing the pigment particle surfaces with ozone, hypochlorous acid, fuming sulfuric acid, or the like or modifying the pigment particle surfaces by sulfonation, or may be dispersed with a resin dispersant and used.

Examples of the resin dispersant include polyvinyl alcohols, polyacrylic acid, acrylic acid-acrylonitrile copolymer, vinyl acetate-acrylate ester copolymer, acrylic acid-acrylate ester copolymer, styrene-acrylic acid copolymer, styrene-methacrylic acid copolymer, styrene-methacrylic acid-acrylate ester copolymer, styrene-α-methylstyrene-acrylic acid copolymer, styrene-α-methylstyrene-acrylic acid-acrylate ester copolymer, styrene-maleic acid copolymer, styrene-maleic anhydride copolymer, vinylnaphthalene-acrylic acid copolymer, vinylnaphthalene-maleic acid copolymer, vinyl acetate-maleate ester copolymer, vinyl acetate-crotonic acid copolymer, vinyl acetate-acrylic acid copolymer, and salts thereof.

Among these, preferred are a copolymer of a monomer having a hydrophobic functional group and a monomer a hydrophilic functional group, and a polymer of a monomer having both a hydrophobic functional group and a hydrophilic functional group. The copolymer can be used in the form of any one of a random copolymer, a block copolymer, an alternative copolymer, and a graft copolymer.

The resin dispersant described above has the function of enhancing the dispersibility of the pigment particles. The resin dispersant has, for example, water solubility. Also or alternatively, the resin dispersant adheres to the pigment and is present around the pigment particles.

The content ratio of the resin dispersant can be properly selected according to the pigment particles to be dispersed, but is preferably 5 parts by mass or more and 200 parts by mass or less and more preferably 20 parts by mass or more and 120 parts by mass or less relative to a content of 100 parts by mass of the pigment particles in the ink.

The content of the pigment particles in the ink relative to the total mass of the ink is preferably 0.3% by mass or more and 20% by mass or less, more preferably 0.5% by mass or more and 15% by mass or less, still more preferably 1% to 10% by mass, and particularly preferably 1.5% to 5% by mass. The pigment particles at a content within the range described above causes little nozzle clogging or the like in an ink jet recording apparatus and thus can sufficiently satisfy a color density. Also, the pigment particles at a content within or higher than the range described above can easily form an image having more excellent color development.

### 3. 2. Resin Particles

The same as the resin particles in the water-insoluble component which may be contained in the treatment liquid composition can be used as the resin particles.

### 3. 3. Physical Properties of Particle Components

The volume-average particle diameter of the particle components such as the pigment particles and resin particles described above contained in the ink jet ink composition is 20 to 500 nm.

The volume-based average particle diameter (D50) (also referred to as the “volume-average particle diameter”) (before mixed in the ink) of the particle components is 20 nm or more, preferably 50 nm or more, more preferably 80 nm or more, still more preferably 110 nm or more, and particularly preferably 150 nm or more. Also, the volume-average particle diameter of the particle components is 500 nm or less, preferably 400 nm or less, more preferably 300 nm or less, still more preferably 250 nm or less, and particularly preferably 200 nm or less. With the volume-average particle diameter within the range described above, easy availability and good characteristics can be easily obtained. Also, when the particle components have a volume-average particle diameter within the range described above, there is a tendency that the particle components are hardly sedimented and thus dispersion stability can be improved, and also nozzle clogging or the like can be made difficult to occur when applied to an ink jet recording apparatus.

The volume-average particle diameter of the particle components can be measured by a particle size distribution measuring device using a laser diffraction scattering method as a measurement principle. The particle size distribution measuring device is, for example, a particle size distribution meter (for example, “Microtrac UPA” manufactured by Nikkiso Co., Ltd.) using a dynamic light scattering method as a measurement principle.

The content of the particle components in terms of solid content relative to the total mass of the ink jet ink composition is 0.2% by mass or more and 40% by mass or less, preferably 2% by mass or more and 30% by mass or less, more preferably 4% by mass or more and 20% by mass or less, and still more preferably 6% by mass or more and 15% by mass or less.

The particle components such as the pigment particles and the resin particles described above, which are contained in the ink jet ink composition, preferably have anionicity. The treatment liquid composition described above contains the polyamide epihalohydrin polymer and the specific quaternary ammonium salt polymer which are cationic polymers. Therefore, when the particle components such as the pigment particles and the resin particles of the ink have anionicity, there is a tendency that aggregation reaction effectively takes place when the treatment liquid composition is mixed with the ink, and thus more excellent color development can be obtained.

A preferred example of the pigment particles with anionicity is pigment particles with a dispersant which has an anionic group and is present on the surfaces thereof, and the dispersant having an anionic group is, for example, a dispersant having —COO— or —SO₃— as an anionic group.

Examples of the resin particles having anionicity include resin particles having an anionic functional group such as a carboxyl group, a sulfo group, a hydroxyl group, or the like, and an anionic urethane-based resin is preferred. Examples of an anionic urethane-based resin among the commercial products of urethane-based resin described above include Superflex 460, 460s, and 840 manufactured by DKS Co., Ltd., Takelac WS-5000, WS-6021, and W-512-A-6 manufactured by Mitsui Chemicals Polyurethane Co., Ltd., and the like.

### 3. 4. Water

The ink jet ink composition included in the ink treatment liquid set according to the present embodiment is an aqueous pigment ink jet ink and contains water. The term “aqueous” represents containing water as a main solvent. The water is the same as that which can be contained in the treatment liquid composition described above.

The content of the water is not particularly limited, but the content relative to the total mass of the ink jet ink composition may be, for example, 40% by mass or more, 50% by mass or more, or 60% by mass or more. The upper limit of the content of water contained in the ink jet ink composition may be 90% by mass or less, 80% by mass or less, or 70% by mass or less.

### 3. 5. Organic Solvent

The ink jet ink composition included in the ink treatment liquid set according to the present embodiment may contain an organic solvent. The organic solvent is preferably a water-soluble organic solvent. The same as those which can be contained in the treatment liquid composition described above can be used as the water-soluble organic solvent.

When the water-soluble organic solvent is contained, the content thereof relative to the total mass of the ink jet ink composition is preferably 30% by mass or less, more preferably 25% by mass or less, and still more preferably 20% by mass or less. Also, the content of the water-soluble organic solvent relative to the total mass of the ink jet ink composition is preferably 5% by mass or more, more preferably 10% by mass or more, and still more preferably 15% by mass or more.

### 3. 6. Surfactant

The ink jet ink composition included in the ink treatment liquid set according to the present embodiment may contain a surfactant. The same as those which can be contained in the treatment liquid composition described above can be used as the surfactant, and also the content thereof can be the same as described above.

### 3. 7. Other Component

If required, the ink jet ink composition included in the ink treatment liquid set according to the present embodiment may contain wax, a pH adjuster, a preservative/anti-mold agent, an anti-rust agent, a chelating agent, a viscosity modifier, a solubilizer, an antioxidant, etc. The description of these components is omitted because these components are the same as those contained in the treatment liquid composition described above.

### 3. 8. Production Method

The ink jet ink composition included in the ink treatment liquid set according to the present embodiment can be produced by mixing the components in any desired order and, if required, removing impurities from the resultant mixture by filtration or the like. A method preferably used as a method for mixing the components includes sequentially adding the materials in a vessel provided with a stirrer, such as a mechanical stirrer, a magnetic stirrer, or the like, and mixing and stirring the materials. If required, a filtration method can be performed by centrifugal filtration, filter filtration, or the like.

### 3. 9. Physical Properties of Ink Jet Ink Composition

The physical properties: pH, surface tension, viscosity, etc., of the ink jet ink composition included in the ink treatment liquid set according to the present embodiment may be adjusted within the respective desired ranges.

The ink jet ink composition has a pH of over 8, preferably a pH of over 9, more preferably a pH of over 10, and still more preferably a pH of over 11. The ink jet ink composition having a pH within the range described above has a tendency that dispersion of the ink is easily destabilizd when mixed with the treatment liquid composition, and aggregation of the particle components is accelerated to more improve color development.

The physical properties such as surface tension and viscosity can be adjusted to be the same as those of the treatment liquid composition described above.

### 4. Treatment Method

A treatment method according to an embodiment of the present disclosure includes adhering the treatment liquid composition to a fabric, and heating the fabric with the treatment liquid composition adhered thereto, the surface temperature of the fabric during heating being 100° C. or more.

The treatment method according to the present embodiment includes a treatment of heating the fabric, to which the treatment liquid composition described above has been adhered, so that the surface temperature becomes 100° C. or more, and the treatment method can achieve both excellent color development and excellent wet friction fastness.

Each of the processes of the treatment method according to the present embodiment is described below.

### 4. 1. Adhesion

The treatment method according to the present embodiment include adhering the treatment liquid composition to a fabric. The treatment liquid composition and fabric are as described above, and thus description thereof is omitted.

Examples of a method (coating method) of adhering the treatment liquid composition to a fabric include a method of dipping the fabric in the treatment liquid composition (dip coating), a method of coating the treatment liquid composition on the fabric using a roll coater (roller coating), a method of spraying the treatment liquid composition using a spray device or the like (spray coating), a method of ejecting the treatment liquid composition by an ink jet method (ink jet coating), and the like. Any one of the methods may be used. The ink jet coating of the treatment liquid composition is preferred in view of the fact that the treatment liquid composition can be easily controlled to be uniformly adhered to the fabric. Also, dip coating or spray coating of the treatment liquid composition is preferred in view of the fact that the treatment liquid composition can be coated on the fabric within a short time.

The coating amount of the treatment liquid composition per unit area of the fabric is preferably 50 to 200 g/m2, more preferably 70 to 170 g/m2, still more preferably 90 to 140 g/m2, and particularly preferably 100 to 120 g/m2. When the coating amount of the treatment liquid composition is within the range described above, the effect exhibited by the present disclosure may be easily acquired.

### 4. 2. Heating

The treatment method according to the present embodiment includes, after the adhesion described above, heating the fabric to which the treatment liquid composition has been adhered. Examples of the heating method include, but are not particularly limited to, a convective heat drying method, a radiant heat drying method, a conductive heat drying method, and the like. In addition, heat generated from a combustion burner of combustible gas, a carbon heater, a ceramic heater, a halogen lamp, or an infrared lamp can be used as a heat source used for heating.

The lower limit value of the surface temperature of the fabric in the heating is preferably 40° C. or more, more preferably 80° C. or more, and still more preferably 100° C. or more. In addition, the upper limit value of the surface temperature of the fabric in the heating is preferably 180° C. or less. With the heating temperature of 180° C. or less, damage due to the thermal stress applied to the fabric during heat drying can be suppressed. While, with the heating temperature equal to or higher than the lower limit value, the moisture and solvent contained in the treatment liquid composition can be efficiently evaporated, thereby accelerating drying of the treated fabric. Further, when the material constituting the fabric contains cotton, the heating temperature of 100° C. or more can accelerate crosslinking reaction of the polyamide epihalohydrin polymer contained in the treatment liquid composition with cellulose fibers in the cotton fabric.

The treatment liquid composition can form an image having at least good wet friction fastness, color development, and light resistance when used for pretreatment of a recording medium for recording an image by the ink jet ink composition.

### 5. Examples and Comparative Examples

The present disclosure is described in further detail below by examples, but the present disclosure is not limited to these examples. Hereinafter, “%” is on a mass basis unless otherwise specified.

### 5. 1. Preparation of Treatment Liquid Composition

Components were mixed at the contents shown in Table 1 to Table 4 below, stirred at room temperature for 2 hours, and then filtered with a membrane filter having a pore diameter of 5 μm, preparing each treatment liquid composition. In Table 1 to Table 4 below, the unit of the contents of compositions is “% by mass”.

### 5. 2. Preparation of Ink Jet Ink Composition

Components were mixed at the contents described below in an example of black ink composition”, stirred at room temperature for 2 hours, and then filtered with a membrane filter having a pore diameter of 5 μm, preparing an ink jet ink composition (black ink). In the example of black ink composition described below, the content of a pigment is a pigment solid content, and the content of resin emulsion is a resin solid content. In addition, the carbon black pigment used for preparing the ink jet ink composition was a black pigment dispersion previously prepared by mixing a pigment dispersant (not described in the composition example below) as a water-soluble styrene acrylic resin with water at a mass ratio of 1:1 (pigment: pigment dispersant) and then sufficiently stirring the resultant mixture.

The example of black ink composition is as follows.

Black pigment dispersion: carbon black pigment 5% by mass

| | |
|---|---|
| Resin emulsion: WS6021 | 6% by mass |
| Glycerin | 6% by mass |
| Trimethylolpropane | 8% by mass |
| Triethylene glycol | 5% by mass |
| EDTA | 0.1% by mass |
| Inorganic alkali: KOH | 0.1% by mass |
| Surfactant: Olfine E1010 | 1% by mass |
| Surfactant: Surfynol 104 | 0.5% by mass |
| Pure water | 68.3% by mass |

The supplementary description of the black ink is given.
Carbon black pigment: C. I. Pigment Black 7
WS6021: Takelac WS-6021, trade name manufactured by Mitsui Chemicals Co., Ltd., solid content: 30% by mass, urethane resin
EDTA: ethylenediamine tetraacetic acid, metal chelating agent
Olfine E1010: trade name manufactured by Nissin Chemical Industry Co., Ltd., acetylene glycol-based surfactant, HLB=14
Surfynol 104: trade name manufactured by Nissin Chemical Industry Co., Ltd., acetylene glycol-based surfactant, HLB=4

The pH of the black ink was over 8. In addition, the pH was measured by immersing an electrode portion in the ink jet ink composition using desktop pH meter F-72 model (manufactured by Horiba, Ltd.).

### 5. 3. Recording Medium

The recording medium used was the following fabric.
Cotton fabric
Fiber: cotton
Type: taffeta
Composition: 100% cotton
Weight: 8.04 to 8.55 (g/m2)
Standard size: 145 to 150 (cm)
Manufacturer: A. FERRARIO
Whiteness L* value: 91.5

The L* value of the fabric was measured by using colorimeter “Gretag Macbeth Spectrolino” (trade name manufactured by X-Rite Inc.).

TABLE 1

| | | | Example | | | | | | |
|---|---|---|---|---|---|---|---|---|---|
| | | | 1 | 2 | 3 | 4 | 5 | 6 | 7 |
| Water- | Polyamide epichlorohydrin | WS4020: Seiko PMC | 1.0 | — | — | — | — | — | — |
| resistant | polymer | Corporation | | | | | | | |
| agent | Polyamide polyamine | AF-255: Arakawa Chemical | — | 1.0 | — | — | — | — | — |
| | epichlorohydrin polymer | Industries, Ltd. | | | | | | | |
| | Dimethylamine | PE-30: Yokkaichi Chemical | — | — | 1.0 | — | — | — | — |
| | ethylenediamine | Co., Ltd. | | | | | | | |
| | epichlorohydrin | | | | | | | | |
| | polycondensate | | | | | | | | |
| | MEKO-blocked isocyanate | PHOBOL_XAN: Huntsman | — | — | — | — | — | — | — |
| | DMP-blocked isocyanate | Fixer#220: Murayama Chemical | — | — | — | 1.0 | — | 0.2 | 0.5 |
| | | Laboratory Co., Ltd. | | | | | | | |
| | DMP-blocked isocyanate | NK ASSIST NY-30: Nicca | — | — | — | — | 1.0 | — | — |
| | | Chemical Co., Ltd. | | | | | | | |
| Polyvalent | Calcium nitrate tetrahydrate | | — | — | — | — | — | — | — |
| metal salt | Calcium chloride dihydrate | | — | — | — | — | — | — | — |
| Cationic | Quaternary ammonium | PAS-J-81: Nittobo Medical | — | — | — | — | — | — | — |
| polymer | salt polymer | Co., Ltd. | | | | | | | |
| | Modified polyamine- | DK6810: Seiko PMC | — | — | — | — | — | — | — |
| | based compound | Corporation | | | | | | | |
| | Polyamine-based | Jetfix N700: Satoda Chemical | 1.0 | 1.0 | 1.0 | 1.0 | 1.0 | 1.0 | 1.0 |
| | compound | Industrial Co., Ltd. | | | | | | | |
| | Polyamine-based | Jetfix 220: Satoda Chemical | — | — | — | — | — | — | — |
| | compound | Industrial Co., Ltd. | | | | | | | |
| Surfactant | Acetylene glycol-based | Surfynol 485 | 0.5 | 0.5 | 0.5 | 0.5 | 0.5 | 0.5 | 0.5 |
| Preservative | Proxel XL2 | | 0.2 | 0.2 | 0.2 | 0.2 | 0.2 | 0.2 | 0.2 |
| pH adjuster | Triethanolamine | | — | — | — | — | 1.0 | — | — |
| Solvent | Pure water | | 97.3 | 97.3 | 97.3 | 97.3 | 96.3 | 98.1 | 97.8 |
| Total | | | 100 | 100 | 100 | 100 | 100 | 100 | 100 |
| Treatment | Drying temperature after | Economax D: M&R Company | 100° C. | 100° C. | 100° C. | 100° C. | 100° C. | 100° C. | 100° C. |
| conditions | coating of pretreatment | | | | | | | | |
| | liquid composition | | | | | | | | |
| | Drying temperature after | Economax D: M&R Company | 160° C. | 160° C. | 160° C. | 160° C. | 160° C. | 160° C. | 160° C. |
| | ink printing | | | | | | | | |
| Evaluation | Spray coating stability | Two fluid nozzle (1008 + spray | A | A | A | A | A | A | A |
| items | | controller): Spraying Systems Co. | | | | | | | |
| | Color development | Black ink 100% Duty | A | A | A | A | A | A | A |
| | Friction fastness | Dry friction strength | A | A | A | A | A | B | A |
| | (Discoloration) | Wet friction strength | A | A | A | A | A | B | B |
| | Texture | Shear rigidity | A | A | A | A | A | AA | A |
| | Light resistance | Yellowing | A | A | A | A | A | A | A |
| | pH | | <6 | <6 | <6 | <6 | 7< | <6 | <6 |

TABLE 2

| | | | Example | | | | | | |
|---|---|---|---|---|---|---|---|---|---|
| | | | 8 | 9 | 10 | 11 | 12 | 13 | 14 |
| Water- | Polyamide epichlorohydrin | WS4020: Seiko PMC | — | — | — | — | — | — | — |
| resistant | polymer | Corporation | | | | | | | |
| agent | Polyamide polyamine | AF-255: Arakawa Chemical | — | — | 1.0 | 0.2 | 0.5 | 2.0 | — |
| | epichlorohydrin polymer | Industries, Ltd. | | | | | | | |
| | Dimethylamine ethylenediamine | PE-30: Yokkaichi Chemical | — | — | — | — | — | — | — |
| | epichlorohydrin polycondensate | Co., Ltd. | | | | | | | |
| | MEKO-blocked isocyanate | PHOBOL_XAN: Huntsman | — | — | — | — | — | — | — |
| | DMP-blocked isocyanate | Fixer#220: Murayama Chemical | 2.0 | 5.0 | — | 2.0 | 0.5 | 0.2 | 1.0 |
| | | Laboratory Co., Ltd. | | | | | | | |
| | DMP-blocked isocyanate | NK ASSIST NY-30: Nicca | — | — | — | — | — | — | — |
| | | Chemical Co., Ltd. | | | | | | | |
| Polyvalent | Calcium nitrate tetrahydrate | | — | — | — | — | — | — | — |
| metal salt | Calcium chloride dihydrate | | — | — | — | — | — | — | — |
| Cationic | Quaternary ammonium salt | PAS-J-81: Nittobo Medical | — | — | — | — | — | — | — |
| polymer | polymer | Co., Ltd. | | | | | | | |
| | Modified polyamine-based | DK6810: Seiko PMC | — | — | 1.0 | — | — | — | — |
| | compound | Corporation | | | | | | | |
| | Polyamine-based compound | Jetix N700: Satoda Chemical | 1.0 | 1.0 | — | 1.0 | 1.0 | 1.0 | 0.2 |
| | | Industrial Co., Ltd | | | | | | | |
| | Polyamine-based compound | Jetfix 220: Satoda Chemical | — | — | — | — | — | — | — |
| | | Industrial Co., Ltd. | | | | | | | |
| Surfactant | Acetylene glycol-based | Surfynol 485 | 0.5 | 0.5 | 0.5 | 0.5 | 0.5 | 0.5 | 0.5 |
| Preservative | Proxel XL2 | | 0.2 | 0.2 | 0.2 | 0.2 | 0.2 | 0.2 | 0.2 |
| pH adjuster | Triethanolamine | | — | — | — | — | — | — | — |
| Solvent | Pure water | | 96.3 | 93.3 | 97.3 | 96.1 | 97.3 | 96.1 | 98.1 |
| Total | | | 100 | 100 | 100 | 100 | 100 | 100 | 100 |
| Treatment | Drying temperature after | Economax D: M&R Company | 100° C. | 100° C. | 100° C. | 100° C. | 100° C. | 100° C. | 100° C. |
| conditions | coating of pretreatment | | | | | | | | |
| | liquid composition | | | | | | | | |
| | Drying temperature after | Economax D: M&R Company | 160° C. | 160° C. | 160° C. | 160° C. | 160° C. | 160° C. | 160° C. |
| | ink printing | | | | | | | | |
| Evaluation | Spray coating stability | Two fluid nozzle | A | B | A | A | A | A | A |
| items | | (1008 + spray controller): | | | | | | | |
| | | Spraying Systems Co. | | | | | | | |
| | Color development | Black ink 100% Duty | A | B | A | A | A | A | B |
| | Friction fastness | Dry friction strength | A | AA | A | A | A | A | AA |
| | (Discoloration) | Wet friction strength | A | A | A | A | A | A | B |
| | Texture | Shear rigidity | A | B | A | A | A | A | A |
| | Light resistance | Yellowing | A | A | A | A | A | A | A |
| | pH | | <6 | <6 | <6 | <6 | <6 | <6 | <6 |

TABLE 3

| | | | Example | | | | | |
|---|---|---|---|---|---|---|---|---|
| | | | 15 | 16 | 17 | 18 | 19 | 20 |
| Water- | Polyamide epichlorohydrin polymer | WS4020: Seiko PMC Corporation | — | — | — | — | — | 1.0 |
| resistant | Polyamide polyamine | AF-255: Arakawa Chemical | — | — | — | 1.0 | — | — |
| agent | epichlorohydrin polymer | Industries, Ltd. | | | | | | |
| | Dimethylamine ethylenediamine | PE-30: Yokkaichi Chemical | — | — | — | — | — | — |
| | epichlorohydrin polycondensate | Co., Ltd. | | | | | | |
| | MEKO-blocked isocyanate | PHOBOL_XAN: Huntsman | — | — | — | — | — | — |
| | DMP-blocked isocyanate | Fixer#220: Murayama Chemical | 1.0 | 1.0 | 1.0 | — | 1.0 | — |
| | | Laboratory Co., Ltd. | | | | | | |
| | DMP-blocked isocyanate | NK ASSIST NY-30: Nicca | — | — | — | — | — | — |
| | | Chemical Co., Ltd. | | | | | | |
| Polyvalent | Calcium nitrate tetrahydrate | | — | — | — | — | — | — |
| metal salt | Calcium chloride dihydrate | | — | — | — | — | — | — |
| Cationic | Quaternary ammonium salt polymer | PAS-J-81: Nittobo Medical Co., Ltd. | — | — | — | — | — | — |
| polymer | Modified polyamine-based compound | DK6810: Seiko PMC Corporation | — | — | — | — | — | — |
| | Polyamine-based compound | Jetfix N700: Satoda Chemical | 0.5 | 2.0 | 5.0 | — | — | 1.0 |
| | | Industrial Co., Ltd | | | | | | |
| | Polyamine-based compound | Jetfix 220: Satoda Chemical | — | — | — | 1.0 | 1.0 | — |
| | | Industrial Co., Ltd. | | | | | | |
| Surfactant | Acetylene glycol-based | Surfynol 485 | 0.5 | 0.5 | 0.5 | 0.5 | 0.5 | 0.5 |
| Preservative | Proxel XL2 | | 0.2 | 0.2 | 0.2 | 0.2 | 0.2 | 0.2 |
| pH adjuster | Triethanolamine | | — | — | — | — | — | — |
| Solvent | Pure water | | 96.3 | 96.3 | 93.3 | 97.3 | 97.3 | 97.3 |
| Total | | | 100 | 100 | 100 | 100 | 100 | 100 |
| Treatment | Drying temperature after coating of | Economax D: M&R Company | 100° C. | 100° C. | 100° C. | 100° C. | 100° C. | 100° C. |
| conditions | pretreatment liquid composition | | | | | | | |
| | Drying temperature after ink printing | Economax D: M&R Company | 160° C. | 160° C. | 160° C. | 160° C. | 160° C. | 160° C. |
| Evaluation | Spray coating stability | Two fluid nozzle (1008 + spray | A | A | A | A | A | A |
| items | | controller): | | | | | | |
| | | Spraying Systems Co. | | | | | | |
| | Color development | Black ink 100% Duty | A | A | AA | A | A | A |
| | Friction fastness | Dry friction strength | A | A | A | A | A | A |
| | (Discoloration) | Wet friction strength | A | A | B | A | A | B |
| | Texture | Shear rigidity | A | A | AA | A | A | AA |
| | Light resistance | Yellowing | A | A | A | A | A | A |
| | pH | | <6 | <6 | <6 | <6 | <6 | <6 |

TABLE 4

| | | | Comparative Example | | | | |
|---|---|---|---|---|---|---|---|
| | | | 1 | 2 | 3 | 4 | 5 |
| Water- | Polyamide epichlorohydrin polymer | WS4020: Seiko PMC Corporation | — | — | — | — | — |
| resistant | Polyamide polyamine epichlorohydrin | AF-255: Arakawa Chemical | 1.0 | — | 1.0 | 1.0 | — |
| agent | polymer | Industries, Ltd. | | | | | |
| | Dimethylamine ethylenediamine | PE-30: Yokkaichi Chemical | — | — | — | — | — |
| | epichlorohydrin polycondensate | Co., Ltd. | | | | | |
| | MEKO-blocked isocyanate | PHOBOL_XAN: Huntsman | — | — | — | — | 1.0 |
| | DMP-blocked isocyanate | Fixer#220: Murayama Chemical | — | — | — | — | — |
| | | Laboratory Co., Ltd. | | | | | |
| | DMP-blocked isocyanate | NK ASSIST NY-30: Nicca | — | — | — | — | — |
| | | Chemical Co., Ltd. | | | | | |
| Polyvalent | Calcium nitrate tetrahydrate | | — | — | 5.0 | — | — |
| metal salt | Calcium chloride dihydrate | | — | — | — | 5.0 | — |
| Cationic | Quaternary ammonium salt polymer | PAS-J-81: Nittobo Medical | — | 1.0 | — | — | — |
| polymer | | Co., Ltd. | | | | | |
| | Modified polyamine-based compound | DK6810: Seiko PMC Corporation | — | — | — | — | — |
| | Polyamine-based compound | Jetfix N700: Satoda Chemical | — | — | — | — | 1.0 |
| | | Industrial Co., Ltd. | | | | | |
| | Polyamine-based compound | Jetfix 220: Satoda Chemical | — | — | — | — | — |
| | | Industrial Co., Ltd. | | | | | |
| Surfactant | Acetylene glycol-based | Surfynol 485 | 0.5 | 0.5 | 3.5 | 0.5 | 0.5 |
| Preservative | Proxel XL2 | | 0.2 | 0.2 | 0.2 | 0.2 | 0.2 |
| pH adjuster | Triethanolamine | | — | — | — | — | — |
| Solvent | Pure water | | 98.3 | 98.3 | 93.3 | 93.3 | 97.3 |
| Total | | | 100 | 100 | 100 | 100 | 100 |
| Treatment | Drying temperature after coating of | Economax D: M&R Company | 100° C. | 100° C. | 100° C. | 100° C. | 100° C. |
| conditions | pretreatment liquid composition | | | | | | |
| | Drying temperature after ink printing | Economax D: M&R Company | 160° C. | 160° C. | 160° C. | 160° C. | 160° C. |
| Evaluation | Spray coating stability | Two fluid nozzle | A | A | A | A | A |
| items | | (1008 + spray controller): | | | | | |
| | | Spraying Systems Co. | | | | | |
| | Color development | Black ink 100% Duty | D | A | AA | AA | A |
| | Friction fastness | Dry friction strength | AA | B | A | A | A |
| | (Discoloration) | Wet friction strength | AA | D | D | D | A |
| | Texture | Shear rigidity | D | AA | AA | AA | A |
| | Light resistance | Yellowing | A | A | A | D | D |
| | pH | | <6 | <6 | <6 | <6 | <6 |

The supplementary description of Table 1 and Table 2 is given.

### Composition

The supplementary description of the polyamide epihalohydrin polymer, the quaternary ammonium salt polymer, the resin particles, the surfactant, and the preservative is as follows.

### Water-Resistant Agent

### Polyamide Epihalohydrin Polymer

Polyamide epichlorohydrin polymer “WS4020” manufactured by Seiko PMC Corporation
Polyamide polyamine epichlorohydrin polymer “AF-255” manufactured by Arakawa Chemical Industries, Ltd.
Dimethylamine ethylenediamine epichlorohydrin polycondensate “PE-30” manufactured by Yokkaichi Chemical Co., Ltd.

### MEKO-Blocked Isocyanate

Methyl ethyl ketoxime: manufactured by HUNTSMAN Corporation, PHOBOL_XAN

### DMP-Blocked Isocyanate

Dimethylpyrazole-blocked isocyanate: Fixer #200, manufactured by Murayama Chemical Laboratory Co., Ltd.
Dimethylpyrazole-blocked isocyanate: NK ASSIST NY-30, manufactured by Nicca Chemical Co., Ltd.

### Cationic Polymer

### Quaternary Ammonium Salt Polymer

Quaternary ammonium salt polymer B: “PAS-J-81”, manufactured by Nittobo Medical Co., Ltd., diallyldimethyl ammonium chloride-acrylamide copolymer, average molecular weight: 180,000
Modified polyamine-based compound: “DK6810”, manufactured by Seiko PMC Corporation
Polyamine-based compound: “Jetfix N700”, manufactured by Satoda Chemical Industrial Co., Ltd.
Polyamine-based compound: “Jetfix 220”, manufactured by Satoda Chemical Industrial Co., Ltd.

### Surfactant

Acetylene glycol: trade name “Surfynol 485, manufactured by Nissin Chemical Industry Co., Ltd., HLB=17

### Preservative

Proxel XL2: trade name manufactured by Lonza Ltd. Treatment condition

In the tables, the drying temperature after coating of the pretreatment liquid composition (treatment liquid composition) and the drying temperature after ink printing are each described as the surface temperature of the fabric in the heat drying treatment using a conveyer drying furnace “Economax D” (manufactured by M & R Company).

### Evaluation Items

A test of evaluating spray coating stability was performed by using a combination of “1008⁺ Spray controller” manufactured by Spraying Systems Co., and a two fluid nozzle forming a flat spray pattern.

Also, pH was measured by immersing an electrode portion in the treatment liquid composition using desktop pH meter F-72 model (manufactured by Horiba, Ltd.).

### 5. 4. Evaluation Method

The spray coating stability, color development, friction fastness, texture, and light resistance were evaluated by evaluation tests. The evaluation methods are as follows.

### 5. 4. 1. Spray Coating Stability (Two Fluid Nozzle)

Each of the treatment liquid compositions prepared as described above was uniformly coated on the surface of the fabric described above in “4. 3. Recording medium” by using a combination of “1008⁺ Spray controller” manufactured by Spraying Systems Co., and a two fluid nozzle forming a flat spray pattern so that the coating amount per unit area was adjusted to 110 g/m2. In this case, a change in coating weight of the treatment liquid composition consumed within a coating treatment time was monitored, and the ability to spray a predetermined amount of consumption without nozzle clogging was evaluated as the spray coating stability. The spray coating stability is determined as follows.

### Determination Criteria

A: The rate of change in coating weight at the end of coating relative to the initial set value is less than ±10%.
B: The rate of change in coating weight at the end of coating relative to the initial set value is ±10% or more and less than 20%.
C: The rate of change in coating weight at the end of coating relative to the initial set value is ±20% or more.

### 5. 4. 2. Color Development (Black Ink 100% Duty)

The fabric coated with the treatment liquid composition by the method described above was dried by heating at the drying temperature described in the tables for 7 minutes using conveyer drying furnace “Economax D” (manufactured by M & R Company), and the treatment of the fabric was completed. Then, an image was printed on the fabric by adhering the ink jet ink composition prepared as described above by an ink jet method using an ink jet printer (trade name “PX-G930” manufactured by Seiko Epson Corporation. In this case, a solid image was printed in a printing pattern (image) with a resolution of 1440×720 dpi within a printing range of 210 mm×297 mm.

The “solid image” represents an image formed by recording dots in all pixels each of which was the minimum recording unit region specified by the recording resolution.

The fabric to which the ink jet ink composition had been adhered was dried by heating at 160° C. for 5 minutes using conveyer drying furnace “Economax D” (manufactured by M & R Company), and then returned to 25° C., forming a printed matter. The color development was evaluated by measuring the optical density (also referred to as the “OD value” hereinafter) of the image on the printed fabric using a fluorescence spectrodensitometer (“FD-7” manufactured by Konica Minolta Inc.). The determination was as follows.

### Determination Criteria

AA: The OD value is 1.5 or more (particularly good).
A: The OD value is 1.4 or more and less than 1.5 (good).
B: The OD value is 1.25 or more and less than 1.4.
D: The OD value is less than 1.25.

### 5. 4. 3. Friction Fastness (Discoloration)

The dry and wet friction resistance of the fabric printed with DUTY 100% by the method described above was tested by a test method according to ISO105-X12 and determined according to criteria below. The wet and dry friction resistance was determined as an OD value difference due to discoloration before and after the friction resistance test according to the criteria below.

### Determination Criteria of Dry Friction Strength

AA: The OD value difference before and after the friction resistance test is less than 0.15 (extremely good).
A: The OD value difference before and after the friction resistance test is 0.15 or more and less than 0.20 (good).
B: The OD value difference before and after the friction resistance test is 0.20 or more and less than 0.25.
D: The OD value difference before and after the friction resistance test is 0.25 or more.

### Determination Criteria of Wet Friction Strength

AA: The OD value difference before and after the friction resistance test is less than 0.20 (extremely good).
A: The OD value difference before and after the friction resistance test is 0.20 or more and less than 0.25 (good).
B: The OD value difference before and after the friction resistance test is 0.25 or more and less than 0.30.
D: The OD value difference before and after the friction resistance test is 0.30 or more.

### 5. 4. 4. Texture (Shear Rigidity)

The shear rigidity of the fabric printed with DUTY 100% by the method described above was evaluated by using tensile shear tester KES-FB1-A manufactured by Kato Tech Co., Ltd. The texture was determined by using the value of shear rigidity according to the criteria below.

### Determination Criteria

AA: The shear rigidity is less than 6.0 gf/cm·deg.
A: The shear rigidity is 6.0 gf/cm·deg or more and less than 8.0 gf/cm·deg.
B: The shear rigidity is 8.0 gf/cm·deg or more and less than 10.0 gf/cm·deg.
D: The shear rigidity is 10.0 gf/cm·deg or more.

### 5. 4. 5. Light Resistance (Yellowing)

The fabric coated with the treatment liquid composition and dried under the conditions described in “4. 4. 2. Color development (black ink 100% Duty)” was irradiated with xenon light with a cumulative irradiance of 20 MJ/m2 using xenon weather meter XL75s manufactured by Suga Test Instruments Co., Ltd. The degree of discoloration of the pretreated fabric was derived as a color difference ΔEab by using fluorescence spectrodensitometer (“FD-7” manufactured by Konica Minolta Inc.). The fabric used for evaluation was the white cotton described above in “4. 3. Recording medium” and showing a L* value of 91.5. The light resistance was determined by using the color difference value according to criteria below.
A: The color difference is less than 2.0.
B: The color difference is 2.0 or more and less than 4.0.
D: The color difference is 4.0 or more.

### 5. 5. Evaluation Results

The evaluation results are shown in above Table 1 to Table 4.

Comparison between the examples and the comparative examples indicates that both excellent color development and excellent wet friction fastness can be achieved by the treatment liquid composition, the set of the ink jet ink composition and the treatment liquid composition, and the treatment method according to the embodiments of the present disclosure.

In more detail, the treatment liquid compositions of the examples can form an image having good wet friction fastness and color development by the effect of improving wet friction fastness and/or water resistance by the water-resistant agent and the effect of satisfying both the color development and fastness by the aggregating agent.

The treatment liquid composition described above may be used by coating a fabric.

In the treatment liquid composition described above, the L* value of the fabric may be 90 or more.

The treatment liquid composition can produce a recorded matter in which yellowing is suppressed in a fabric causing easily noticeable yellowing.

The treatment liquid composition may have a pH of less than 7.

The treatment liquid composition more improves the reactivity with an ink jet ink composition and thus can form an image having more excellent friction fastness and/or color development because dispersion destabilization and aggregation of the components in the ink are accelerated when the ink jet ink composition comes in contact with the treatment liquid composition.

The ink set is a set of an ink jet ink composition and any one of the treatment liquid compositions described above, and the ink jet ink composition is an aqueous pigment ink jet ink containing pigment particles and resin particles, and the ink composition has a pH of over 8 and contains the particle components having a volume-average particle diameter of 20 nm or more and 500 nm or less.

The ink set uses the treatment liquid composition described above and thus can produce an image satisfying both excellent color development and excellent wet friction fastness.

In the ink set, the particle components may have anionicity.

The ink set can produce an image having more excellent color development because the particle components such as the pigment particles and the resin particles in the ink jet ink composition have anionicity and thus aggregation reaction more efficiently takes place by the water-resistant agent in the treatment liquid composition when the treatment liquid composition is mixed with the ink.

The treatment method includes adhering any one of the treatment liquid compositions described above to a fabric, and heating the fabric to which the treatment liquid composition has been adhered, the surface temperature of the fabric during heating being 100° C. or more.

The treatment method can dry the treated fabric by efficiently evaporating the water and solvent contained in the treatment liquid composition. Further, when the material constituting the fabric contains cotton, the heating temperature of 100° C. or more can accelerate crosslinking reaction with cellulose fibers in the cotton fabric by the water-resistant agent contained in the treatment liquid composition.

The embodiments and modified examples described above are examples and are not limited to these. For example, the embodiments and modified examples can be properly combined.

The present disclosure includes substantially the same configuration as that described in the embodiments, for example, a configuration having the same function, method, and results, or a configuration having the same object and effect. The present disclosure also includes a configuration in which a portion not essential in the configuration described in the embodiment is replaced. Further, the present disclosure includes a configuration which can exhibit the same operational effect or achieve the same object as in the configuration described in the embodiment. Further, the present disclosure includes a configuration in which a known technology is added to the configuration described in the embodiment.

Contents below can be derived from the embodiments and modified examples described above.

A treatment liquid composition contains a water-resistant agent selected from a polyamide epihalohydrin polymer and dimethylpyrazole-blocked isocyanate, and a polyamine compound.

The treatment liquid composition can produce an image having at least good wet friction fastness, color development, and light resistance when used for pretreatment of a recording medium for recording an image with an ink jet ink composition.

In more detail, the treatment liquid composition can form an image having good wet friction fastness and color development by the effect of improving wet friction fastness and/or water resistance by the water-resistant agent and the effect of satisfying both the color development and fastness by the aggregating agent.

The treatment liquid composition described above may be used by coating a fabric.

In the treatment liquid composition described above, the L* value of the fabric may be 90 or more.

The treatment liquid composition can produce a recorded matter in which yellowing is suppressed in a fabric causing easily noticeable yellowing.

The treatment liquid composition may have a pH of less than 7.

The treatment liquid composition more improves the reactivity with an ink jet ink composition and thus can form an image having more excellent friction fastness and/or color development because dispersion destabilization and aggregation of the component in the ink are accelerated when the ink jet ink composition comes in contact with the treatment liquid composition.

An ink set is a set of an ink jet ink composition and any one of the treatment liquid compositions described above, and the ink jet ink composition is an aqueous pigment ink jet ink containing pigment particles and resin particles, and the ink composition has a pH of over 8 and contains the particle components having a volume-average particle diameter of 20 nm or more and 500 nm or less.

The ink set uses the treatment liquid composition described above and thus can produce an image satisfying both excellent color development and excellent wet friction fastness.

In the ink set, the particle components may have anionicity.

The ink set can produce an image having more excellent color development because the particle components such as the pigment particles and the resin particles in the ink jet ink composition have anionicity and thus aggregation reaction more efficiently takes place by the water-resistant agent in the treatment liquid composition when the treatment liquid composition is mixed with the ink.

A treatment method includes adhering any one of the treatment liquid compositions described above to a fabric, and heating the fabric to which the treatment liquid composition has been adhered, the surface temperature of the fabric during heating being 100° C. or more.

The treatment method can dry the treated fabric by efficiently evaporating the water and solvent contained in the treatment liquid composition. Further, when the material constituting the fabric contains cotton, the heating temperature of 100° C. or more can accelerate crosslinking reaction with cellulose fibers in the cotton fabric by the water-resistant agent contained in the treatment liquid composition.

What is claimed is:

1. A treatment liquid composition comprising:
a water-resistant agent selected from a polyamide epihalohydrin polymer and dimethylpyrazole-blocked isocyanate; and
a polyamine compound.

2. The treatment liquid composition according to claim 1, wherein the composition is used by coating a fabric.

3. The treatment liquid composition according to claim 1, wherein the L* value of the fabric is 90 or more.

4. The treatment liquid composition according to claim 1, wherein the pH of the treatment liquid composition is less than 7.

5. A set of an ink jet ink composition and a treatment liquid composition, comprising an ink jet ink composition and the treatment liquid compositions according to claim 1,
wherein the ink jet ink composition is an aqueous pigment ink jet ink containing pigment particles and resin particles; and
the ink composition has a pH of over 8 and contains the particle components having a volume-average particle diameter of 20 nm or more and 500 nm or less.

6. The set of an ink jet ink composition and a treatment liquid composition according to claim 5, wherein the particle components have anionicity.

7. A treatment method comprising:
adhering the treatment liquid compositions according to claim 1 to a fabric; and
heating the fabric to which the treatment liquid composition has been adhered,
wherein the surface temperature of the fabric during heating is 100° C. or more.
